(19) United States
(12) Patent Application Publication
(10) Pub. No.: US 2023/0212386 A1
(43) Pub. Date: Jul. 6, 2023

(54) EPOXY MOLDING COMPOUNDS, PREPARATION METHOD THEREOF, AND USE THEREOF

(71) Applicant: JCET GROUP CO., LTD., Wuxi City (CN)

(72) Inventors: XINWEN WEI, Wuxi City (CN); HAOJIE ZHANG, Wuxi City (CN); YUESHENG ZHANG, Wuxi City (CN); HU PU, Wuxi City (CN)

(21) Appl. No.: 18/091,355

(22) Filed: Dec. 29, 2022

(30) Foreign Application Priority Data
Jan. 4, 2022 (CN) 202210002693.2

(51) Int. Cl. C08L 63/00; C08J 3/20

(52) U.S. Cl. CPC C08L 63/00; C08J 3/203; C08L 2205/025; C08L 2205/035; C08J 2363/00; C08J 2371/10; C08J 2463/00; C08J 2471/10

(57) ABSTRACT

The present disclosure provides an epoxy molding compound composition, a preparation method and use thereof. The epoxy molding compound composition includes the following ingredients in mass percentage: epoxy resin: 4-9 wt %; a curing agent: 4-9 wt %; PN phenolic resin: 1-3 wt %; a curing accelerator: 0.02-0.5 wt %; filler: 70-90 wt %; a coupling agent: 0.2-0.6 wt %; and auxiliary additives: 1-2 wt %. By adding the PN phenolic resin to an epoxy resin system of the epoxy molding compound composition, reducing the mass percentage of the coupling agent and removing a plasticizer, the thermal deformation of the molding compound composition can be effectively reduced, and the stability of a packaged product is improved.

### TECHNICAL FIELD

The present disclosure belongs to the technical field of electronic packaging materials, and particularly relates to an epoxy molding compound composition, a preparation method and use thereof.

### BACKGROUND

Epoxy resin is a thermosetting resin, and is widely used in the field of semiconductor packaging due to its good reliability and excellent operating performance. At present, the mainstream molding compound composition is formed from polyfunctional epoxy resin and biphenyl epoxy resin as main resin components, phenolic resin as a curing agent, silica microspheres as filler and appropriate other additives such as a flame retardant, a coupling agent, a mold release agent and a plasticizer, and has been widely used in packaging of various electronic products.

With the increasing integration level of chips, the requirements for the computing power of IC chips are also constantly increasing. With the improvement in the techniques of the photolithography process, the size of a single IC chip is also increasing, which, however, also requires a synchronous improvement of the packaging technique. In terms of QFN (Quad Flat No-leads Package) products, when the size of such products does not exceed 9×9 mm, the mainstream molding compound composition can meet the requirement for high reliability.

However, when the size of such products exceeds 9×9 mm, it is customary in the art to define QFN packages with the size exceeding 9×9 mm as oversized QFN. In terms of the oversized QFN packages, not only the reliability of the molding compound, but also the temperature change of the product during working should be considered. The temperature change may lead to thermal deformation of the oversized QFN products, and it is necessary to avoid reliability problems such as delamination, warpage, and solder joint failure caused by the thermal deformation.

It has been proved by research that after packaging the oversized QFN product with the existing mainstream molding compound composition, the maximum thermal deformation of the molding compound exceeds 200 m in the temperature cycling from room temperature to 260° C., which can no longer meet the requirement of the product for stable operation. Therefore, it is necessary to develop a molding compound composition applicable to oversized QFN packages and has low thermal deformation.

### SUMMARY

An objective of the present disclosure is to provide an epoxy molding compound composition, a preparation method and use thereof. The epoxy molding compound composition has small thermal deformation, especially when used in a QFN product having a size exceeding 9×9 mm, and makes the package product have higher reliability.

In order to solve the above problem, a technical solution of the present disclosure provides an epoxy molding compound composition. The epoxy molding compound composition includes the following ingredients in mass percentage:

epoxy resin: 4-9 wt %;

curing agent: 4-9 wt %;

PN phenolic resin: 1-3 wt %;

curing accelerator: 0.02-0.5 wt %;

filler: 70-90 wt %;

coupling agent: 0.2-0.6 wt %; and

auxiliary additives: 1-2 wt %.

As an optional technical solution, the epoxy molding compound composition includes no phthalate plasticizers.

As an optional technical solution, the epoxy resin is selected from any one or more ofo-methyl phenolic epoxy resin, aliphatic glycidyl ether epoxy resin, polyphenol glycidyl ether epoxy resin, glycidyl ester epoxy resin, glycidyl amine epoxy resin, biphenyl epoxy resin, bisphenol A epoxy resin, bisphenol F epoxy resin, cycloaliphatic epoxy resin and heterocyclic epoxy resin.

As an optional technical solution, the curing agent is selected from any one or more of phenol linear phenolic resin and derivatives thereof, cresol linear phenolic resin and derivatives thereof, monohydroxy or dihydroxy naphthalene phenolic resin, biphenyl phenolic resin, and aralkyl phenol epoxy resin and derivatives thereof.

As an optional technical solution, the curing accelerator is selected from imidazole compounds and salts thereof.

As an optional technical solution, the filler is selected from any one or more of alumina micro powder, spherical silica micro powder and angular silica micro powder.

As an optional technical solution, the coupling agent is selected from any one or more of epoxy silane coupling agent, amino silane coupling agent and mercapto silane coupling agent.

As an optional technical solution, the auxiliary additives include a mold release agent, a colorant, a stress releasing agent, a flame retardant and an ion trapping agent.

As an optional technical solution, the percentage of the PN phenolic resin is 1-3 wt %; and the percentage of the coupling agent is 0.2-0.4 wt %.

The present disclosure further provides a preparation method of the epoxy molding compound composition. The preparation method includes:

step 1: mixing the epoxy resin, the curing agent and the PN phenolic resin to obtain a mixture 1;

step 2: adding the curing accelerator, the filler, the coupling agent and the auxiliary additives to the mixture 1 to obtain a mixture 2; and

step 3: adding the mixture 2 to a twin screw extrusion-injection molding machine at a preset temperature of 150° C., cooling an extruded product with a fan, pulverizing the extruded product and making into a cake, thereby obtaining the epoxy molding compound composition.

The present disclosure further provides use of the above epoxy molding compound composition in packaging of semiconductor components.

Compared with the prior art, the present disclosure provides the epoxy molding compound composition, the preparation method and the use thereof. By adding the PN phenolic resin to an epoxy resin system of the epoxy molding compound composition, reducing the mass percentage of the coupling agent and removing a plasticizer, the thermal deformation of the molding compound composition can be effectively reduced, and the stability of a packaged product is improved.

The present disclosure is described in detail below with reference to the specific embodiments, but is not used as a limit to the present disclosure.

### DETAILED DESCRIPTION

In order to make the objectives, technical solutions, and advantages of the present disclosure clearer and more comprehensible, the following further describes the present disclosure in detail with reference to embodiments. It should be understood that the embodiments herein are provided for describing the present disclosure only and not intended to limit the present disclosure.

An objective of the present disclosure is to design an epoxy molding compound composition. The epoxy molding compound composition includes the following ingredients in mass percentage: epoxy resin: 4-9 wt %; curing agent: 4-9 wt %; PN phenolic resin: 1-3 wt %; curing accelerator: 0.02-0.5 wt %; filler: 70-90 wt %; coupling agent: 0.2-0.6 wt %; and auxiliary additives: 1-2 wt %.

The mass percentage is, taking the total mass of the epoxy molding compound composition as 100, a count of the ratio of the mass of each ingredient to the total mass.

In addition, the epoxy molding compound composition provided by the present disclosure includes no phthalate plasticizers. In other examples of the present application, the epoxy molding compound composition may further include, in mass percentage, 0.01-0.5 wt % of non-phthalate plasticizer. The non-phthalate plasticizer may be selected from any one or more of aliphatic dibasic acid esters, phenyl polyacid esters, benzoic acid esters, polyol esters, chlorinated hydrocarbons, epoxides, citric acid esters and polyesters.

The ingredients will be described and explained in detail below.

The epoxy resin is selected from any one or more ofo-methyl phenolic epoxy resin, aliphatic glycidyl ether epoxy resin, polyphenol glycidyl ether epoxy resin, glycidyl ester epoxy resin, glycidyl amine epoxy resin, biphenyl epoxy resin, bisphenol A epoxy resin, bisphenol F epoxy resin, cycloaliphatic epoxy resin and heterocyclic epoxy resin.

In the epoxy molding compound composition, preferably, the polyfunctional epoxy resin or bisphenol A epoxy resin is used.

The PN phenolic resin is linear phenolic resin of the following structure.

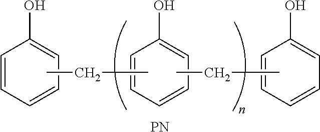

The epoxy resin and the phenolic resin may be crosslinked and cured by the reaction between the hydroxyl in the phenolic aldehyde structure and the epoxide group. Due to its linear structure, the PN phenolic resin has low high-temperature modulus, and the cured product obtained after crosslinking and curing with the epoxy resin has small thermal deformation at high temperature.

The curing agent is selected from any one or more of phenol linear phenolic resin and derivatives thereof, cresol linear phenolic resin and derivatives thereof, monohydroxy or dihydroxy naphthalene phenolic resin, biphenyl phenolic resin, and aralkyl phenol epoxy resin and derivatives thereof.

The curing accelerator is selected from any one or more of imidazole compounds and salts thereof. The imidazole compounds including: 2-methylimidazole, 2,4-dimethylimidazole, 2-ethyl-4-methylimidazole, 2-phenylimidazole, 2-phenyl-4-methylimidazole. The salt compounds including: triethylaminobenzyldimethylamine, α-methyl-benzyldimethylamine, 2-(dimethylaminomethyl)phenol and 2,4,6-tris(dimethylaminomethyl)phenol).

The filler is selected from any one or more of alumina micro powder, spherical silica micro powder and angular silica micro powder.

The coupling agent is selected from any one or more of an epoxy silane coupling agent, an amino silane coupling agent and a mercapto silane coupling agent. The coupling agent is used for coating the filler, especially the inorganic filler, so as to increase the mutual bonding between the epoxy resin system and the filler. In addition, it has been verified by experiments that the excessive mass percentage of the coupling agent in the epoxy molding compound composition will lead to excessive deformation amplitude in the cooling section of the temperature cycling.

In the epoxy molding compound composition, preferably, the mass percentage of the coupling agent is 0.2-0.6 wt %; and more preferably, the mass percentage of the coupling agent is 0.2-0.4 wt %. The coupling agent is the epoxy silane coupling agent, γ-(2,3-epoxypropoxy)propyltrimethoxysilane (KH560).

The auxiliary additives include a mold release agent, a colorant, a stress releasing agent, a flame retardant, an ion trapping agent and the like.

The mold release agent is selected from any one or more of fatty acids, montanic acid, polyethylene wax, polypropylene wax, palm wax and Fischer-Tropsch wax.

The colorant is, for example, selected from carbon black.

The stress releasing agent is selected from any one or more of polysiloxane rubber powder, liquid silicone oil and silicone modified epoxy resin.

The flame retardant is selected from any one or more of metal hydroxides and phosphorus-containing compounds. Preferably, the metal hydroxide is selected from aluminum hydroxide and magnesium hydroxide; and the phosphorus-containing compound is selected from ammonium polyphosphate organic flame retardants, esters of phosphoric acid and alcohol (such as trimethyl phosphate, triethyl phosphate, triphenyl phosphate, trihydroxytolyl phosphate, trixylyl phosphate and cresyl diphenyl phosphate) and the like.

The ion trapping agent mainly includes one or more of bismuth trioxide trihydrate, zirconium hydrogen phosphate dihydrate and aluminum magnesium compounds.

A preparation method of the epoxy molding compound of the present disclosure includes:

step 1: the epoxy resin, the curing agent and the PN phenolic resin are mixed to obtain a mixture 1;

step 2: the curing accelerator, the filler, the coupling agent and the auxiliary additives are added to the mixture 1 to obtain a mixture 2; and

step 3: the mixture 2 is added to a twin screw extrusion-injection molding machine at a preset temperature of 150° C., and an extruded product is cooled with a fan, pulverized, and made into a cake, thereby obtaining the molding compound composition.

It has been verified by experiments that after the molding compound composition described above is used for packaging a semiconductor component and cured at 175° C. for 4 hours, the thermal deformation of the molding compound is reduced by 50%-70% in temperature cycling from room temperature to 260° C. as compared with the existing molding compound composition, so the molding compound composition of the present disclosure is especially suitable for packaging of oversized QFN products having a size exceeding 9×9 mm that have high requirements for thermal deformation and high integration level.

### Example 1

Step 1: 2 wt % of bisphenol A epoxy resin, 2 wt % of polyfunctional epoxy resin, 2 wt % of biphenyl phenolic resin and 2 wt % of phenol phenolic resin were mixed to form a mixture 1.

Step 2: 0.6 wt % of coupling agent KH560, 0.1 wt % of diisobutyl phthalate (a plasticizer), 90 wt % of spherical silica micro powder, 0.3 wt % of Mg₆Al₂(CO₃)(OH)₁₆·4H₂O, 0.5 wt % of carnauba wax, 0.2 wt % of silicone modified epoxy resin, 0.2 wt % of 2-ethyl-4-methylimidazole and 0.1 wt % of carbon black were added to the mixture 1 to obtain a mixture 2.

Step 3: The mixture 2 was added to a twin screw extrusion-injection molding machine at a preset temperature of 150° C., and an extruded product was cooled with a fan, pulverized, and made into a cake, thereby obtaining an epoxy molding compound composition 1.

### Example 2

Step 1: 3 wt % of bisphenol A epoxy resin, 1 wt % of polyfunctional epoxy resin, 3 wt % of biphenyl phenolic resin and 1 wt % of phenol phenolic resin were mixed to form a mixture 1.

Step 2: 0.6 wt % of coupling agent KH560, 0.1 wt % of diisobutyl phthalate (a plasticizer), 90 wt % of spherical silica micro powder, 0.3 wt % of Mg₆Al₂(CO₃)(OH)₁₆·4H₂O, 0.5 wt % of carnauba wax, 0.2 wt % of silicone modified epoxy resin, 0.2 wt % of 2-ethyl-4-methylimidazole and 0.1 wt % of carbon black were added to the mixture 1 to obtain a mixture 2.

Step 3: The mixture 2 was added to a twin screw extrusion-injection molding machine at a preset temperature of 150° C., and an extruded product was cooled with a fan, pulverized, and made into a cake, thereby obtaining an epoxy molding compound composition 2.

### Example 3

Step 1: 2 wt % of bisphenol A epoxy resin, 2 wt % of polyfunctional epoxy resin, 1 wt % of biphenyl phenolic resin and 3 wt % of phenol phenolic resin were mixed to form a mixture 1.

Step 2: 0.6 wt % of coupling agent KH560, 0.1 wt % of diisobutyl phthalate (a plasticizer), 90 wt % of spherical silica micro powder, 0.3 wt % of Mg₆Al₂(CO₃)(OH)₁₆·4H₂O, 0.5 wt % of carnauba wax, 0.2 wt % of silicone modified epoxy resin, 0.2 wt % of 2-ethyl-4-methylimidazole and 0.1 wt % of carbon black were added to the mixture 1 to obtain a mixture 2.

Step 3: The mixture 2 was added to a twin screw extrusion-injection molding machine at a preset temperature of 150° C., and an extruded product was cooled with a fan, pulverized, and made into a cake, thereby obtaining an epoxy molding compound composition 3.

### Example 4

Step 1: 2.5 wt % of bisphenol A epoxy resin, 2 wt % of polyfunctional epoxy resin, 2 wt % of biphenyl phenolic resin and 2 wt % of phenol phenolic resin were mixed to form a mixture 1.

Step 2: 0.6 wt % of coupling agent KH560, 0.1 wt % of diisobutyl phthalate (a plasticizer), 88.5 wt % of spherical silica micro powder, 1 wt % of magnesium hydroxide, 0.3 wt % of Mg₆Al₂(CO₃)(OH)₁₆·4H₂O, 0.5 wt % of carnauba wax, 0.2 wt % of silicone modified epoxy resin, 0.2 wt % of 2-ethyl-4-methylimidazole and 0.1 wt % of carbon black were added to the mixture 1 to obtain a mixture 2.

Step 3: The mixture 2 was added to a twin screw extrusion-injection molding machine at a preset temperature of 150° C., and an extruded product was cooled with a fan, pulverized, and made into a cake, thereby obtaining an epoxy molding compound composition 4.

### Example 5

Step 1: 3.2 wt % of bisphenol A epoxy resin, 1 wt % of polyfunctional epoxy resin, 1 wt % of PN phenolic resin, 2 wt % of biphenyl phenolic resin and 1 wt % of phenol phenolic resin were mixed to form a mixture 1.

Step 2: 0.4 wt % of coupling agent KH560, 0.1 wt % of diisobutyl phthalate (a plasticizer), 90 wt % of spherical silica micro powder, 0.3 wt % of Mg₆Al₂(CO₃)(OH)₁₆·4H₂O, 0.5 wt % of carnauba wax, 0.2 wt % of silicone modified epoxy resin, 0.2 wt % of 2-ethyl-4-methylimidazole and 0.1 wt % of carbon black were added to the mixture 1 to obtain a mixture 2.

Step 3: The mixture 2 was added to a twin screw extrusion-injection molding machine at a preset temperature of 150° C., and an extruded product was cooled with a fan, pulverized, and made into a cake, thereby obtaining an epoxy molding compound composition 5.

### Example 6

Step 1: 3.4 wt % of bisphenol A epoxy resin, 1 wt % of polyfunctional epoxy resin, 3 wt % of biphenyl phenolic resin and 1 wt % of phenol phenolic resin were mixed to form a mixture 1.

Step 2: 0.2 wt % of coupling agent KH560, 0.1 wt % of diisobutyl phthalate (a plasticizer), 90 wt % of spherical silica micro powder, 0.3 wt % of magnesium hydroxide, 0.3 wt % of Mg₆Al₂(CO₃)(OH)₁₆·4H₂O, 0.5 wt % of carnauba wax, 0.2 wt % of silicone modified epoxy resin, 0.2 wt % of 2-ethyl-4-methylimidazole and 0.1 wt % of carbon black were added to the mixture 1 to obtain a mixture 2.

Step 3: The mixture 2 was added to a twin screw extrusion-injection molding machine at a preset temperature of 150° C., and an extruded product was cooled with a fan, pulverized, and made into a cake, thereby obtaining an epoxy molding compound composition 6.

### Example 7

Step 1: 3.3 wt % of bisphenol A epoxy resin, 1 wt % of polyfunctional epoxy resin, 3 wt % of biphenyl phenolic resin and 1 wt % of phenol phenolic resin were mixed to form a mixture 1.

Step 2: 0.4 wt % of coupling agent KH560, 90 wt % of spherical silica micro powder, 0.3 wt % of magnesium hydroxide, 0.3 wt % of Mg₆Al₂(CO₃)(OH)₁₆·4H₂O, 0.5 wt % of carnauba wax, 0.2 wt % of silicone modified epoxy resin, 0.2 wt % of 2-ethyl-4-methylimidazole and 0.1 wt % of carbon black were added to the mixture 1 to obtain a mixture 2.

Step 3: The mixture 2 was added to a twin screw extrusion-injection molding machine at a preset temperature of 150° C., and an extruded product was cooled with a fan, pulverized, and made into a cake, thereby obtaining an epoxy molding compound composition 7.

### Example 8

Step 1: 3.3 wt % of bisphenol A epoxy resin, 1 wt % of polyfunctional epoxy resin, 2 wt % of PN phenolic resin, 3 wt % of biphenyl phenolic resin and 1 wt % of phenol phenolic resin were mixed to form a mixture 1.

Step 2: 0.4 wt % of coupling agent KH560, 90 wt % of spherical silica micro powder, 0.3 wt % of magnesium hydroxide, 0.3 wt % of Mg₆Al₂(CO₃)(OH)₁₆·4H₂O, 0.5 wt % of carnauba wax, 0.2 wt % of silicone modified epoxy resin, 0.2 wt % of 2-ethyl-4-methylimidazole and 0.1 wt % of carbon black were added to the mixture 1 to obtain a mixture 2.

Step 3: The mixture 2 was added to a twin screw extrusion-injection molding machine at a preset temperature of 150° C., and an extruded product was cooled with a fan, pulverized, and made into a cake, thereby obtaining an epoxy molding compound composition 8.

### Example 9

Step 1: 3.3 wt % of bisphenol A epoxy resin, 1 wt % of polyfunctional epoxy resin, 3 wt % of PN phenolic resin, 3 wt % of biphenyl phenolic resin and 1 wt % of phenol phenolic resin were mixed to form a mixture 1.

Step 2: 0.2 wt % of coupling agent KH560, 90 wt % of spherical silica micro powder, 0.3 wt % of magnesium hydroxide, 0.3 wt % of Mg₆Al₂(CO₃)(OH)₁₆·4H₂O, 0.5 wt % of carnauba wax, 0.2 wt % of silicone modified epoxy resin, 0.2 wt % of 2-ethyl-4-methylimidazole and 0.1 wt % of carbon black were added to the mixture 1 to obtain a mixture 2.

Step 3: The mixture 2 was added to a twin screw extrusion-injection molding machine at a preset temperature of 150° C., and an extruded product was cooled with a fan, pulverized, and made into a cake, thereby obtaining an epoxy molding compound composition 9.

The ingredients and mass percentages thereof in Examples 1-9 are shown in Table 1.

| | Example | | | | | | | | |
|---|---|---|---|---|---|---|---|---|---|
| Ingredient wt % | 1 | 2 | 3 | 4 | 5 | 6 | 7 | 8 | 9 |
| Bisphenol A epoxy | 2 | 3 | 2 | 2.5 | 3.2 | 3.4 | 3.3 | 3.3 | 3.3 |
| resin | | | | | | | | | |
| Polyfunctional | 2 | 1 | 2 | 2 | 1 | 1 | 1 | 1 | 1 |
| epoxy resin | | | | | | | | | |
| PN phenolic resin | 0 | 0 | 0 | 0 | 1 | 0 | 0 | 2 | 3 |
| Biphenyl phenolic | 2 | 3 | 1 | 2 | 2 | 3 | 3 | 1 | 1 |
| resin | | | | | | | | | |
| Phenol phenolic | 2 | 1 | 3 | 2 | 1 | 1 | 1 | 1 | 1 |
| resin | | | | | | | | | |
| Coupling agent | 0.6 | 0.6 | 0.6 | 0.6 | 0.4 | 0.2 | 0.4 | 0.4 | 0.2 |
| (KH560) | | | | | | | | | |
| Diisobutyl phthalate | 0.1 | 0.1 | 0.1 | 0.1 | 0.1 | 0.1 | 0 | 0 | 0 |
| Spherical silica | 90 | 90 | 90 | 88.5 | 90 | 90 | 90 | 90 | 90 |
| micro powder | | | | | | | | | |
| Magnesium | 0 | 0 | 0 | 1 | 0 | 0.3 | 0.3 | 0.3 | 0.3 |
| hydroxide | | | | | | | | | |
| Mg₆Al₂(CO₃)(OH)₁₆•4H₂O | 0.3 | 0.3 | 0.3 | 0.3 | 0.3 | 0.3 | 0.3 | 0.3 | 0.3 |
| Carnauba wax | 0.5 | 0.5 | 0.5 | 0.5 | 0.5 | 0.5 | 0.5 | 0.5 | 0.5 |
| Silicone modified | 0.2 | 0.2 | 0.2 | 0.2 | 0.2 | 0.2 | 0.2 | 0.2 | 0.2 |
| epoxy resin | | | | | | | | | |
| 2-ethyl-4-methylimid | 0.2 | 0.2 | 0.2 | 0.2 | 0.2 | 0.2 | 0.2 | 0.2 | 0.2 |
| azole | | | | | | | | | |
| Carbon black | 0.1 | 0.1 | 0.1 | 0.1 | 0.1 | 0.1 | 0.1 | 0.1 | 0.1 |

Evaluation methods of the epoxy molding compound compositions 1-9 prepared in Examples 1-9 are as follows, and the evaluation results are shown in Table 2.

Gelation time: hot plate method: a 5×5 cm electric hot plate was heated to 175±1° C. 0.3-0.5 g of sample powder (the molding compound compositions 1-9) was taken and placed on the electric hot plate. The powder was pressed back and forth with a 21 mm-wide scraper until the powder was transformed from liquid to gel. The time required was recorded with a stopwatch.

Spiral flow length: 20±5 g of sample powder (the epoxy molding compound compositions 1-9) was taken and successively placed in an EMMI-1-66 spiral flow metal mold and then tested for its spiral flow length. The injection pressure was 70±2 Kgf/cm², the injection speed was 22±3 mm/s, and the mold temperature was 175±2° C.

Glass transition temperature and thermal expansion coefficient: the prepared sample powder (the epoxy molding compound compositions 1-9) was successively placed in a thermal expansion coefficient analyzer and tested for the relationship between the thermal expansion value of the sample and the temperature, i.e., thermal expansion coefficient, and the intersection of two lines of thermal expansion coefficient was the glass transition temperature.

Flexural modulus: the bending strength test was carried out by the three point loading method. A rectangular test sample obtained by packaging with the powder (the epoxy molding compound compositions 1-9) was placed on two supports. Then a concentrated load was applied to the midpoint of the two supports, so as to make the test sample produce a bending stress and deformation. The flexural modulus was calculated according to the relationship between the bending stress and the deformation.

Maximum thermal deformation: a 17×17 mm sample (formed from the epoxy molding compound compositions 1-9) was placed in a temperature-controlled chamber whose internal temperature was set to temperature cycling from room temperature to 260° C., and the thermal deformation at the corresponding temperature point was tested. CP23T Table 2 Evaluation results of epoxy molding compound compositions 1-9.

TABLE 2
Evaluation results of epoxy molding compound compositions 1-9.

| | Molding | | Molding | | Molding | | Molding | | Molding | | Molding | | Molding | | Molding | | Molding | |
|---|---|---|---|---|---|---|---|---|---|---|---|---|---|---|---|---|---|---|
| | compound | | compound | | compound | | compound | | compound | | compound | | compound | | compound | | compound | |
| | composition | | composition | | composition | | composition | | composition | | composition | | composition | | composition | | composition | |
| | 1 | | 2 | | 3 | | 4 | | 5 | | 6 | | 7 | | 8 | | 9 | |
| Gelation | 45 | | 50 | | 60 | | 45 | | 63 | | 60 | | 58 | | 58 | | 55 | |
| time (s) | | | | | | | | | | | | | | | | | | |
| Spiral flow | 105 | | 140 | | 152 | | 152 | | 146 | | 145 | | 146 | | 146 | | 146 | |
| length | | | | | | | | | | | | | | | | | | |
| (cm) | | | | | | | | | | | | | | | | | | |
| Glass | 145 | | 135 | | 150 | | 120 | | 131 | | 130 | | 131 | | 131 | | 131 | |
| transition | | | | | | | | | | | | | | | | | | |
| temperature | | | | | | | | | | | | | | | | | | |
| (° C.) | | | | | | | | | | | | | | | | | | |
| Thermal | 7 | | 7 | | 7 | | 8 | | 6 | | 6 | | 6 | | 6 | | 6 | |
| expansion | | | | | | | | | | | | | | | | | | |
| coefficient 1 | | | | | | | | | | | | | | | | | | |
| (ppm) | | | | | | | | | | | | | | | | | | |
| Thermal | 27 | | 27 | | 27 | | 30 | | 25 | | 24 | | 25 | | 25 | | 24 | |
| expansion | | | | | | | | | | | | | | | | | | |
| coefficient 2 | | | | | | | | | | | | | | | | | | |
| (ppm) | | | | | | | | | | | | | | | | | | |
| Flexural | 27 | GPa | 27 | GPa | 26 | GPa | 25 | GPa | 27 | GPa | 26 | GPa | 27 | GPa | 27 | GPa | 27 | GPa |
| modulus | | | | | | | | | | | | | | | | | | |
| (room | | | | | | | | | | | | | | | | | | |
| temperature) | | | | | | | | | | | | | | | | | | |
| Flexural | 1.7 | MPa | 1.0 | MPa | 0.8 | MPa | 0.6 | MPa | 0.8 | MPa | 0.7 | MPa | 0.8 | MPa | 0.8 | MPa | 0.8 | MPa |
| modulus | | | | | | | | | | | | | | | | | | |
| (260° C.) | | | | | | | | | | | | | | | | | | |

| | | | | | | | | | |
|---|---|---|---|---|---|---|---|---|---|
| Maximum | 163 | 171 | 154 | 179 | 91 | 103 | 89 | 72 | 68 |
| thermal | | | | | | | | | |
| deformation | | | | | | | | | |
| (μm) | | | | | | | | | |

The epoxy molding compound compositions 1-3 formed in Examples 1-3 and their performance testing showed that changing the content and type of each ingredient in the mixture 1 composed of the bisphenol A epoxy resin, the polyfunctional epoxy resin, the biphenyl phenolic resin and the phenol phenolic resin had no significant effect on the thermal deformation of the molding compound composition.

The epoxy molding compound compositions 1 and 4 formed in Examples 1 and 4 and their performance testing showed that reducing the addition amount of silica alone had no significant effect on the thermal deformation of the molding compound composition.

The epoxy molding compound compositions 2, 5 and 6 formed in Examples 2, 5 and 6 and their performance testing showed that in a resin system in which the mass percentage of the coupling agent was reduced (the addition amount was reduced) and the PN phenolic resin was added, when the content of the coupling agent was reduced to 0.4, the maximum thermal deformation may be kept within 100 m.

The epoxy molding compound compositions 6 and 7 formed in Examples 6 and 7 and their performance testing showed that when the plasticizer was removed or the mass percentage of the coupling agent was reduced (the addition amount was reduced), the thermal deformation of the molding compound composition may be lower. Removing the phthalate plasticizer may avoid the thermal deformation caused by the dissolution of the phthalate plasticizer in the high-temperature section of the temperature cycling from room temperature to 260° C. Meanwhile, reducing the mass percentage of the coupling agent to 0.2-0.6 wt % may ensure the bonding between the filler and the epoxy resin system while making the epoxy molding compound composition have lower thermal deformation in the cooling section of the temperature cycling from room temperature to 260° C.

The epoxy molding compound compositions 5, 7, 8 and 9 formed in Examples 5, 7, 8 and 9 and their performance testing showed that removing the plasticizer in the molding compound composition and adding a proper amount of PN phenolic resin may reduce the thermal deformation of the epoxy molding compound composition and also slow down the change of curvature. Due to its low high-temperature modulus, when the PN phenolic resin was added to the existing epoxy resin system, the change of curvature of the thermal deformation of the epoxy molding compound composition became slow in the high-temperature section of the temperature cycling from room temperature to 260° C.

As can be seen from Examples 1-9 and their performance testing, reducing the content of the coupling agent is beneficial to the reduction of the maximum thermal deformation in the cooling section of the temperature cycling; and removing the plasticizer and adding the PN phenolic resin at the same time are also beneficial to the reduction of the maximum thermal deformation of the epoxy molding compound composition at high temperature. Adding the PN phenolic resin to the epoxy resin system, removing the plasticizer and reducing the content of the coupling agent can obtain the optimal beneficial effects, thereby effectively reducing the thermal deformation of the epoxy molding compound composition and ensuring the stability of the epoxy molding compound composition after being used for packaging.

The present disclosure further provides use in semiconductor packaging based on the epoxy molding compound composition.

Based on the above, the present disclosure provides the epoxy molding compound composition, the preparation method and the use thereof. By adding the PN phenolic resin to the epoxy resin system of the epoxy molding compound composition, removing the plasticizer and reducing the mass percentage of the coupling agent in the epoxy molding compound composition, the thermal deformation of the molding compound composition can be effectively reduced, and the stability of a packaged product is improved.

The present disclosure has been described by using the foregoing related embodiments. However, the foregoing embodiments are merely examples for implementing the present disclosure. In addition, technical features involved in different implementations of the present disclosure described above may be combined together if there is no conflict. It should be noted that, the present disclosure may further have a plurality of other embodiments. A person skilled in the art may make various corresponding changes and variations according to the present disclosure without departing from the spirit and essence of the present disclosure. However, such corresponding changes and variations shall fall within the protection scope of the claims appended to the present disclosure.

What is claimed is:

1. An epoxy molding compound composition, comprising the following ingredients in mass percentage:
epoxy resin: 4-9 wt %;
curing agent: 4-9 wt %;
PN phenolic resin: 1-3 wt %;
curing accelerator: 0.02-0.5 wt %;
filler: 70-90 wt %;
coupling agent: 0.2-0.6 wt %; and
auxiliary additives: 1-2 wt %.

2. The epoxy molding compound composition according to claim 1, wherein the epoxy molding compound composition comprises no phthalate plasticizers.

3. The epoxy molding compound composition according to claim 1, wherein the epoxy resin is selected from any one or more ofo-methyl phenolic epoxy resin, aliphatic glycidyl ether epoxy resin, polyphenol glycidyl ether epoxy resin, glycidyl ester epoxy resin, glycidyl amine epoxy resin, biphenyl epoxy resin, bisphenol A epoxy resin, bisphenol F epoxy resin, cycloaliphatic epoxy resin and heterocyclic epoxy resin.

4. The epoxy molding compound composition according to claim 1, wherein the curing agent is selected from any one or more of phenol linear phenolic resin and derivatives thereof, cresol linear phenolic resin and derivatives thereof, monohydroxy or dihydroxy naphthalene phenolic resin, biphenyl phenolic resin, and aralkyl phenol epoxy resin and derivatives thereof.

5. The epoxy molding compound composition according to claim 1, wherein the curing accelerator is selected from imidazole compounds and salts thereof.

6. The epoxy molding compound composition according to claim 1, wherein the filler is selected from any one or more of alumina micro powder, spherical silica micro powder and angular silica micro powder.

7. The epoxy molding compound composition according to claim 1, wherein the coupling agent is selected from any one or more of an epoxy silane coupling agent, an amino silane coupling agent and a mercapto silane coupling agent.

8. The epoxy molding compound composition according to claim 1, wherein the auxiliary additives comprise a mold release agent, a colorant, a stress releasing agent, a flame retardant and an ion trapping agent.

9. The epoxy molding compound composition according to claim 1, wherein the percentage of the PN phenolic resin is 1-3 wt %; and the percentage of the coupling agent is 0.2-0.4 wt %.

10. A preparation method of an epoxy molding compound composition, comprising:
step 1: mixing the epoxy resin, the curing agent and the PN phenolic resin to obtain a mixture 1;
step 2: adding the curing accelerator, the filler, the coupling agent and the auxiliary additives to the mixture 1 to obtain a mixture 2; and
step 3: adding the mixture 2 to a twin screw extrusion-injection molding machine at a preset temperature of 150° C., cooling an extruded product with a fan, pulverizing the extruded product and making into a cake, thereby obtaining the epoxy molding compound composition;
wherein the mass percentage of each ingredient is as following:
epoxy resin: 4-9 wt %;
curing agent: 4-9 wt %;
PN phenolic resin: 1-3 wt %;
curing accelerator: 0.02-0.5 wt %;
filler: 70-90 wt %;
coupling agent: 0.2-0.6 wt %; and
auxiliary additives: 1-2 wt %.

11. The preparation method of the epoxy molding compound composition according to claim 10, wherein the epoxy molding compound composition comprises no phthalate plasticizers.

12. The preparation method of the epoxy molding compound composition according to claim 10, wherein the epoxy resin is selected from any one or more ofo-methyl phenolic epoxy resin, aliphatic glycidyl ether epoxy resin, polyphenol glycidyl ether epoxy resin, glycidyl ester epoxy resin, glycidyl amine epoxy resin, biphenyl epoxy resin, bisphenol A epoxy resin, bisphenol F epoxy resin, cycloaliphatic epoxy resin and heterocyclic epoxy resin;
wherein the curing agent is selected from any one or more of phenol linear phenolic resin and derivatives thereof, cresol linear phenolic resin and derivatives thereof, monohydroxy or dihydroxy naphthalene phenolic resin, biphenyl phenolic resin, and aralkyl phenol epoxy resin and derivatives thereof,
wherein the curing accelerator is selected from imidazole compounds and salts thereof;
wherein the filler is selected from any one or more of alumina micro powder, spherical silica micro powder and angular silica micro powder;
wherein the coupling agent is selected from any one or more of an epoxy silane coupling agent, an amino silane coupling agent and a mercapto silane coupling agent;
wherein the auxiliary additives comprise a mold release agent, a colorant, a stress releasing agent, a flame retardant and an ion trapping agent;
wherein the percentage of the PN phenolic resin is 1-3 wt %; and the percentage of the coupling agent is 0.2-0.4 wt %.

13. Use of the epoxy molding compound composition according claim 1 in packaging of semiconductor components.

14. The use of the epoxy molding compound composition according to claim 13, wherein the epoxy molding compound composition comprises no phthalate plasticizers.

15. The use of the epoxy molding compound composition according to claim 13, wherein the epoxy resin is selected from any one or more ofo-methyl phenolic epoxy resin, aliphatic glycidyl ether epoxy resin, polyphenol glycidyl ether epoxy resin, glycidyl ester epoxy resin, glycidyl amine epoxy resin, biphenyl epoxy resin, bisphenol A epoxy resin, bisphenol F epoxy resin, cycloaliphatic epoxy resin and heterocyclic epoxy resin;
wherein the curing agent is selected from any one or more of phenol linear phenolic resin and derivatives thereof, cresol linear phenolic resin and derivatives thereof, monohydroxy or dihydroxy naphthalene phenolic resin, biphenyl phenolic resin, and aralkyl phenol epoxy resin and derivatives thereof,
wherein the curing accelerator is selected from imidazole compounds and salts thereof;
wherein the filler is selected from any one or more of alumina micro powder, spherical silica micro powder and angular silica micro powder;
wherein the coupling agent is selected from any one or more of an epoxy silane coupling agent, an amino silane coupling agent and a mercapto silane coupling agent;
wherein the auxiliary additives comprise a mold release agent, a colorant, a stress releasing agent, a flame retardant and an ion trapping agent;
wherein the percentage of the PN phenolic resin is 1-3 wt %; and the percentage of the coupling agent is 0.2-0.4 wt %.
